(19) United States
(12) Patent Application Publication
(10) Pub. No.: US 2025/0262917 A1
(43) Pub. Date: Aug. 21, 2025

(54) ENERGY ABSORBER

(71) Applicant: MORIROKU TECHNOLOGY COMPANY, LTD., Tokyo (JP)

(72) Inventors: Kiyoshi Murakami, Tokyo (JP); Hiromu Sawatari, Tokyo (JP)

(21) Appl. No.: 19/052,918

(22) Filed: Feb. 13, 2025

(30) Foreign Application Priority Data
Feb. 20, 2024 (JP) 2024-023425
Dec. 18, 2024 (JP) 2024-221559

(51) Int. Cl. B60J 5/04

(52) U.S. Cl. CPC B60J 5/0458

(57) ABSTRACT

An energy absorber includes a connecting portion provided between a protrusion and a fixing portion, and a part or all of the connecting portion is an inclined portion. When an external force is applied in a direction inclined with respect to an axis of the protrusion, the inclined portion is deformed, and the protrusion changes in direction so that its axis is aligned with the external force, and the energy absorber is crushed to absorb energy.

### FIELD OF THE INVENTION

The present invention relates to an energy absorber disposed between a door panel and a door trim.

A door trim is a lining member that is provided on a passenger compartment side of a door panel. There is known an energy absorber capable of enhancing occupant protection and disposed between the door trim and the door panel.

Various shapes of energy absorbers of this type have been proposed (for example, JP 2022-140743 A).

Patent Document 1 (JP 2022-140743 A) will be described with reference to the following drawings. FIG. 10A is a partially cross-sectional view of a vehicle with a conventional energy absorber. As illustrated in FIG. 10A, a seat 102 for an occupant to sit thereon is disposed in a passenger compartment 101 of a vehicle 100. A door 110 disposed beside the seat 102 includes a door panel 111 having a hollow structure, a window glass 112, and a door trim 113 serving as an interior lining member.

Then, an energy absorber 120 is provided between the door trim 113 and the door panel 111. The energy absorber 120 absorbs the energy by crushing. When a large force is applied from outside the vehicle toward the passenger compartment 101, the door panel 111 deforms and enters the passenger compartment 101. Then, the door trim 113 hits the seat 102, and the energy absorber 120 is crushed. Due to this crushing, a large force is reduced, and the influence on the occupant sitting on the seat 102 is reduced.

FIG. 10B is an enlarged view of a part b of FIG. 10A. As shown in FIG. 10B, the energy absorber 120 includes a flange 121 which is fixed to the door trim 113, a large diameter cylindrical portion 122 which extends from the flange 121 toward the door panel 111, a large diameter doughnut plate 123 which is provided at the tip of the large diameter cylindrical portion 122, a medium diameter cylindrical portion 124 which extends from the edge of the hole of the large diameter doughnut plate 123 toward the door panel 111, a medium diameter doughnut plate 125 which is provided at the tip of the medium diameter cylindrical portion 124, a small diameter cylindrical portion 126 which extends from the edge of the hole of the medium diameter doughnut plate 125 toward the door panel 111, and a lid 127 which blocks the tip opening of the small diameter cylindrical portion 126. The energy absorber 120 has a stepped shape in cross section.

FIG. 10C is an operational view of the conventional energy absorber 120. Since the energy absorber 120 has a stepped shape, the energy absorber is easily crushed as shown in FIG. 10C. When considering the crushing, since the large diameter doughnut plate 123 and the medium diameter doughnut plate 125 are perpendicular to an axis 128 of action of an external force, they are easily bent. Therefore, the energy absorber 120 is crushed stably as a whole. On the other hand, the energy absorber 120 absorbs energy gently, and the energy absorbing performance is reduced.

There may be a demand for improving the energy absorbing performance of the energy absorber 120. Therefore, various structures having higher energy absorbing performance than that of Patent Document 1 have been proposed (for example, JP 2015-205671 A).

Patent Document 2 will be described with reference to the following drawings. FIG. 11 is a cross-sectional view of another conventional energy absorber. As shown in FIG. 11, an energy absorber 130 includes a flange 131, a tapered cylindrical portion 132 which extends from the flange 131 and has a tapered shape, and a lid 133 which blocks the tip opening of the tapered cylindrical portion 132.

In such an energy absorber 130, since the large diameter doughnut plate 123 and the medium diameter doughnut plate 125 shown in FIG. 10B do not exist, the energy absorbing performance increases as the rigidity increases.

That is, when an external force F1 is applied along an axis 134 of the tapered cylindrical portion 132, the tapered cylindrical portion 132 is crushed to exhibit a desired energy absorbing performance. However, when an external force F2 is applied in a direction inclined with respect to the axis 134 of the tapered cylindrical portion 132, an angles θa and θb do not change easily. Accordingly, since the tapered cylindrical portion 132 is distorted and crushed, the energy absorbing performance decreases, leading to instability.

Incidentally, in the case of a side collision, in which a large external force is applied to a vehicle from the side, the frequency of the external force F2 is higher than that of the external force F1. Therefore, there is a demand for an energy absorber that can stably absorb energies that are input obliquely.

An object of the present invention is to provide an energy absorber capable of stably absorbing an energy that is input obliquely.

### SUMMARY

A disclosed energy absorber provided between a vehicle door panel and a door trim covering the door panel from a passenger compartment and serving as an interior part of the passenger compartment includes: a protrusion which protrudes from the door trim side toward the door panel side and has a tip capable of receiving the door panel and a base end spaced apart from a rear surface of the door trim; and a fixing portion which is provided on an outer periphery of the base end of the protrusion and is fixable to the door trim, wherein the base end of the protrusion and the fixing portion are connected through an annular connecting portion, and wherein the connecting portion has an inclined portion which approaches the door trim as it moves radially inward with respect to an axis of the protrusion.

The present invention provides an energy absorber that can stably absorb an energy that is input obliquely.

### BRIEF DESCRIPTION OF THE DRAWINGS

FIG. 1A is a cross-sectional view of an energy absorber according to a first embodiment, and FIG. 1B is a diagram illustrating a form in which the energy absorber is attached to a vehicle.

FIG. 2A is a diagram illustrating an operation of an energy absorber according to a comparative example, and FIGS. 2B and 2C are diagrams illustrating an effect of the energy absorber according to the embodiment.

FIG. 3 is a cross-sectional view of an energy absorber according to a second embodiment.

FIG. 4 is a cross-sectional view of an energy absorber according to a third embodiment.

FIG. 5 is a cross-sectional view of an energy absorber according to a fourth embodiment.

FIG. 6 is a cross-sectional view of an energy absorber according to a fifth embodiment.

FIG. 7 is a cross-sectional view of an energy absorber according to a sixth embodiment.

FIG. 8 is a cross-sectional view of an energy absorber according to a seventh embodiment.

FIG. 9 is a graph illustrating an energy absorbing amount.

FIG. 10A is a partially cross-sectional view of a vehicle with a conventional energy absorber, FIG. 10B is an enlarged view of a part b of FIG. 10A, and FIG. 10C is an operational view of the conventional energy absorber.

FIG. 11 is a cross-sectional view of another conventional energy absorber.

### DETAILED DESCRIPTION

Embodiments of the present invention will be described below with reference to the accompanying drawings. Furthermore, the drawings should be viewed in the direction of the symbols.

### EMBODIMENTS

### Energy Absorber According to First Embodiment

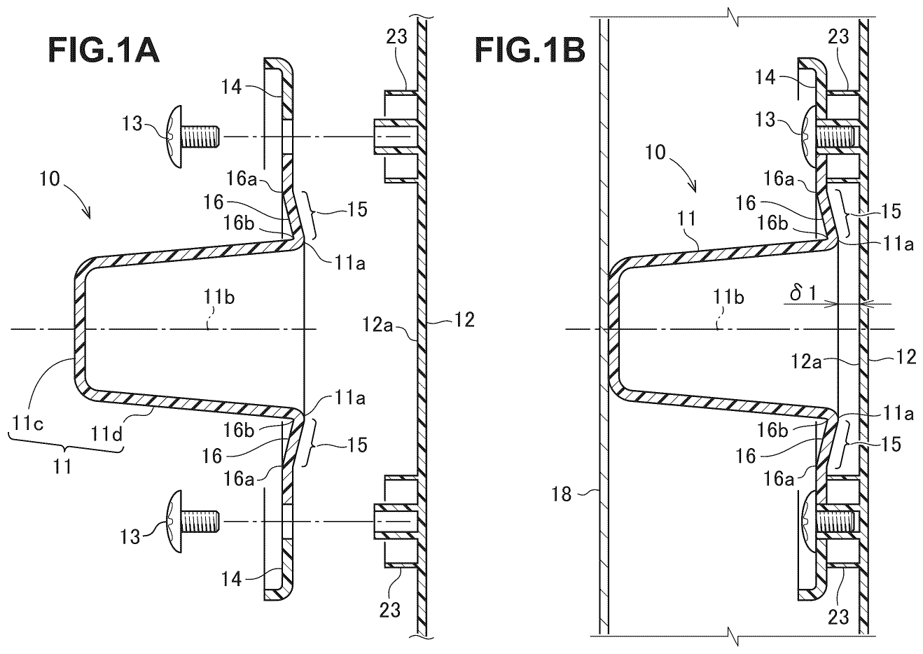

As illustrated in FIG. 1A, an energy absorber 10 includes a pointed tapered protrusion 11, a fixing portion 14 fixed to a door trim 12 by a fastener 13 such as a bolt, and a connecting portion 15 connecting the fixing portion 14 and a base end 11a of the protrusion 11. The connecting portion 15 has an annular shape to surround the base end 11a of the protrusion 11.

Then, the connecting portion 15 has an inclined portion 16 that approaches the door trim 12 as it moves radially inward with respect to an axis 11b of the protrusion 11. This inclined portion 16 may constitute all or a part of the connecting portion 15.

Furthermore, since the connecting portion 15 has an annular shape, the inclined portion 16 also has an annular shape. Due to the annular shape, the inclined portion 16 has an outer peripheral portion 16a and an inner peripheral portion 16b. In other words, the inclined portion 16 is inclined so that the inner peripheral portion 16b approaches the door trim 12 along the axis 11b of the protrusion 11 relative to the outer peripheral portion 16a.

The energy absorber 10 is basically made of resin, but may be made of light metal such as an aluminum alloy or a magnesium alloy.

The fastener 13 is basically a bolt, but may be a screw, a headed pin, a tapping screw, a rivet, or an adhesive.

FIG. 1B illustrates the energy absorber 10 with such a structure attached to a vehicle door.

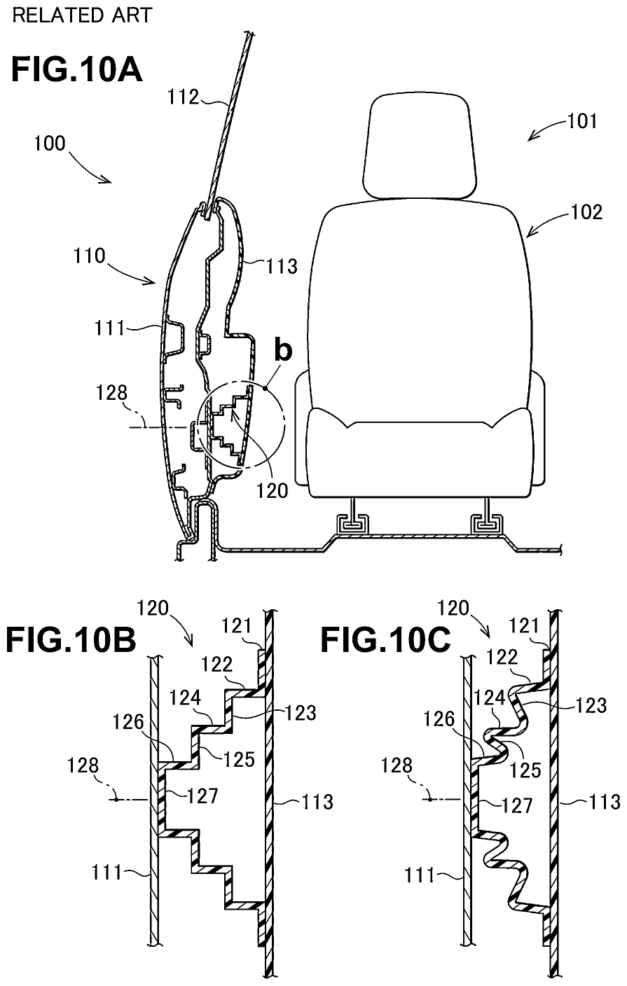

As illustrated in FIG. 1B, the energy absorber 10 is provided between a door panel 18 and the door trim 12 which covers the door panel 18 from the passenger compartment side (FIG. 10, reference numeral 101) and serves as an interior part of the passenger compartment.

The protrusion 11 of the energy absorber 10 protrudes from the door trim 12 toward the door panel 18 and has a tip capable of receiving the door panel 18 and the base end 11a spaced apart from a rear surface 12a of the door trim 12 by δ1.

The fixing portion 14 of the energy absorber 10 is provided on the outer periphery of the base end 11a of the protrusion 11, and is fixable to the door trim 12.

The connecting portion 15 of the energy absorber 10 is an annular portion which connects the base end 11a of the protrusion 11 and the fixing portion 14, and has the inclined portion 16.

The inclined portion 16 included in the connecting portion 15 is inclined so as to approach the door trim as it moves radially inward with respect to the axis 11b of the protrusion 11.

Furthermore, the inclined portion 16 is also a portion inclined so that the inner peripheral portion 16b approaches the door trim 12 along the axis 11b of the protrusion 11 relative to the outer peripheral portion 16a.

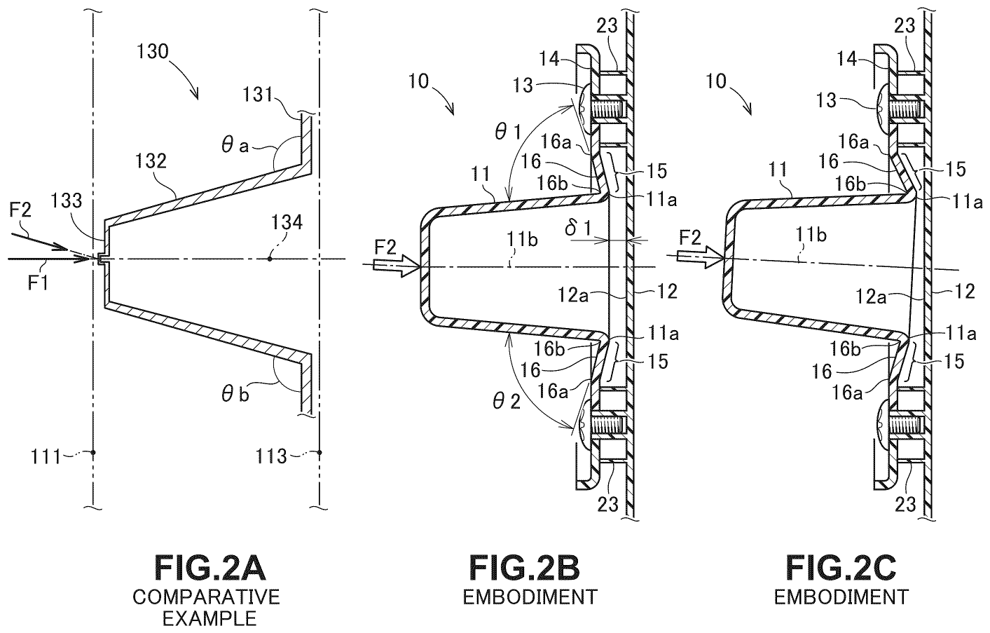

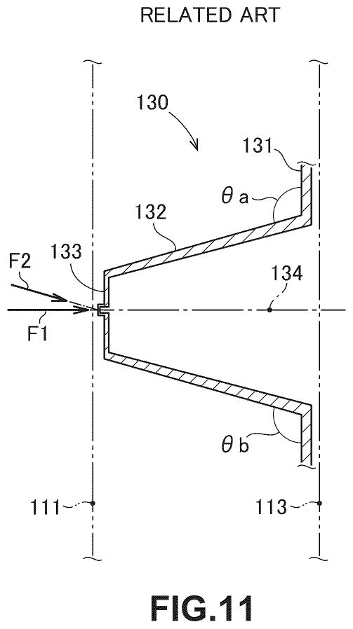

The operation of the energy absorber 10 with the above-described configuration will be described with reference to FIGS. 2A to 2C. Furthermore, FIG. 2A is a reprint of FIG. 11.

In FIG. 2A, the angles formed between the flange 131 and the tapered cylindrical portion 132 are represented as θa and θb.

Since the conventional energy absorber 130 has a high rigidity, θa and θb do not change easily even when subjected to an oblique external force F2. As a result, the energy absorber 130 is not crushed in a predetermined manner, but is crushed in a distorted manner. In a distorted collapsing manner, the energy absorbing performance is reduced and the structure becomes unstable.

Additionally, in the embodiment illustrated in FIG. 2B, the inclined portion 16 is included in the connecting portion 15 that connects the protrusion 11 and the fixing portion 14. The angles formed between the inclined portion 16 and the protrusion 11 are represented as θ1 and θ2.

Since the intersection of the inclined portion 16 and the protrusion 11 forms a V-shaped cross section, the interior angles θ1 and θ2 of this V shape change with a smaller force than the angles θa and θb illustrated in FIG. 2A.

Specifically, the angle θ1 becomes smaller as the base end 11a in the vicinity of the angle θ1 approaches the door trim 12. On the other hand, the base end 11a in the vicinity of the angle θ2 is displaced less, and the angle θ2 becomes larger.

As a result, as illustrated in FIG. 2C, the protrusion 11 is inclined so that the axis 11b is aligned with the force F2. Thereafter, the force F2 causes the energy absorber 10 to be crushed in a predetermined manner along the axis 11b.

Furthermore, the above-described action is smoothly performed by the base end 11a spaced apart from the rear surface of the door trim 12 by δ1.

Therefore, the energy absorber 10 that can stably absorb energies that are input obliquely is provided due to the presence of the inclined portion 16 and the distance 81.

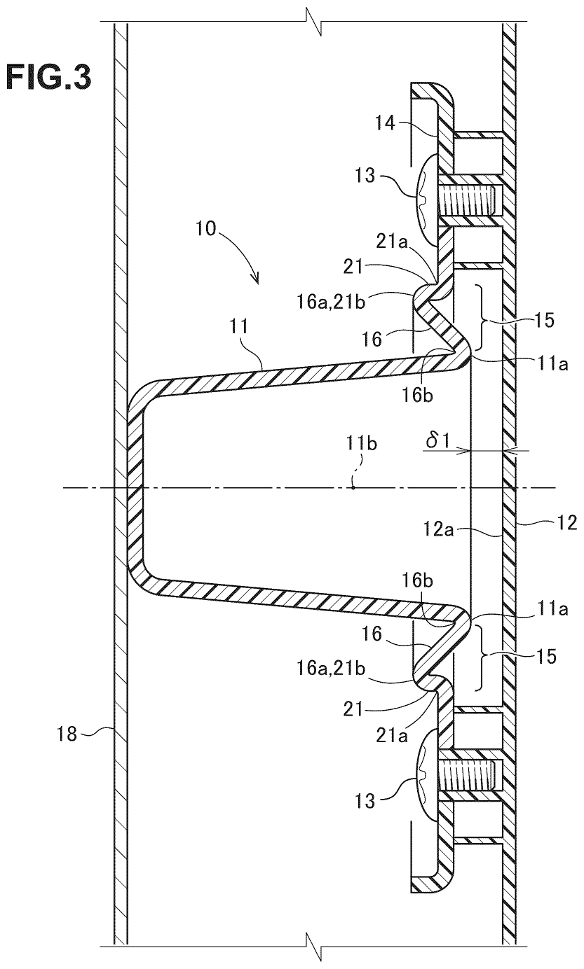

Next, modified examples of the present invention will be described in order with reference to FIGS. 3 to 6.

### Energy Absorber According to Second Embodiment

The form of the energy absorber 10 according to a second embodiment will be described with reference to FIG. 3.

The energy absorber 10 illustrated in FIG. 3 is different from that of FIG. 1B in that the connecting portion 15 is provided with a second inclined portion 21 in addition to the inclined portion 16. Since the other elements are not changed, detailed description thereof will be omitted by using the reference numerals of FIG. 1B.

As illustrated in FIG. 3, the second inclined portion 21 is disposed at a portion that connects the inclined portion 16 and the fixing portion 14. Then, the second inclined portion 21 is inclined to move away from the door trim 12 as it moves radially inward with respect to the axis 11b of the protrusion 11.

That is, the second inclined portion 21 has an outer peripheral portion 21a and an inner peripheral portion 21b, and the inner peripheral portion 21b is inclined along the axis 11b of the protrusion 11 to move away from the door trim 12 relative to the outer peripheral portion 21a.

### Operation and Effect of Second Embodiment

As obvious from FIG. 3, the protrusion 11 and the inclined portion 16 form a V-shaped cross section, and the inclined portion 16 and the second inclined portion 21 form a second V-shaped cross section. As a result, the deformability at the connection portion 15 is doubled. When the deformability is doubled, the change from FIGS. 2B to 2C occurs more quickly, and the effect of the present invention is more reliably achieved.

### Energy Absorber According to Third Embodiment

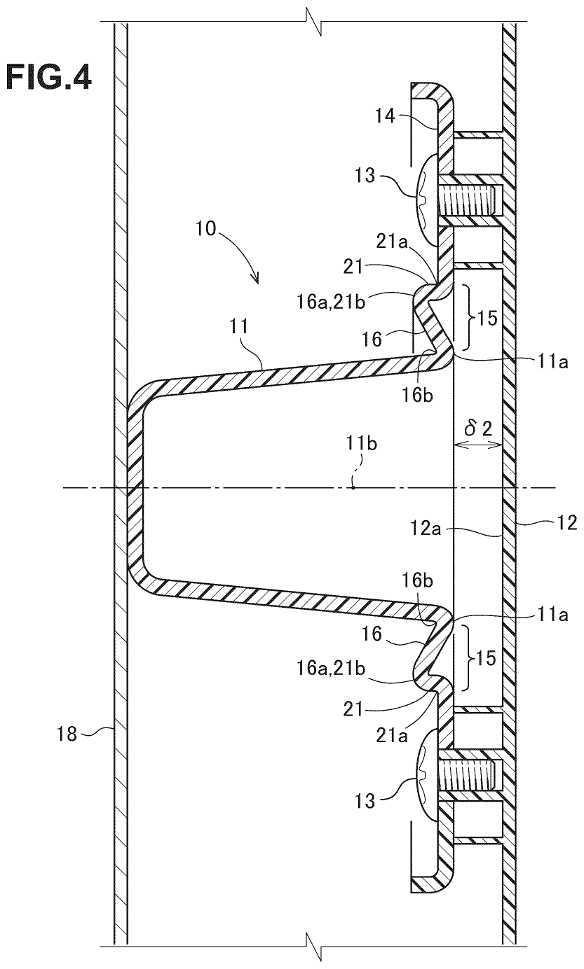

The form of the energy absorber 10 according to a third embodiment will be described with reference to FIG. 4.

The energy absorber 10 illustrated in FIG. 4 is different from that of FIG. 3 in that the distance between the rear surface 12a of the door trim 12 and the tip of the base end 11a is set to δ2 larger than δ1. Since the other elements are not changed, detailed description thereof will be omitted by using the reference numerals of FIG. 3.

That is, the rear surface 12a of the door trim 12 has a base portion 23 that protrudes toward the door panel 18. The fixing portion 14 is fixable to the base portion 23. Then, the base end 11a of the protrusion 11 is located at the same position as the tip of the base portion 23 with respect to the extension direction of the axis 11b of the protrusion 11.

### Operation and Effect of Third Embodiment

Since the distance between the rear surface 12a of the door trim 12 and the tip of the base end 11a is set to a sufficiently large value δ2, the base end 11a is less likely to come into contact with the rear surface 12a of the door trim 12, and the effect of the present invention can be more reliably achieved.

In addition, since the base end 11a of the protrusion 11 is located at the same position as the tip of the base portion 23, the tip of the fixing portion 14 and the base end 11a are aligned on the same plane. Since they are aligned on the same plane, there is an advantage that the design of the die is easier for both resin molding dies and press molding dies.

### Energy Absorber According to Fourth Embodiment

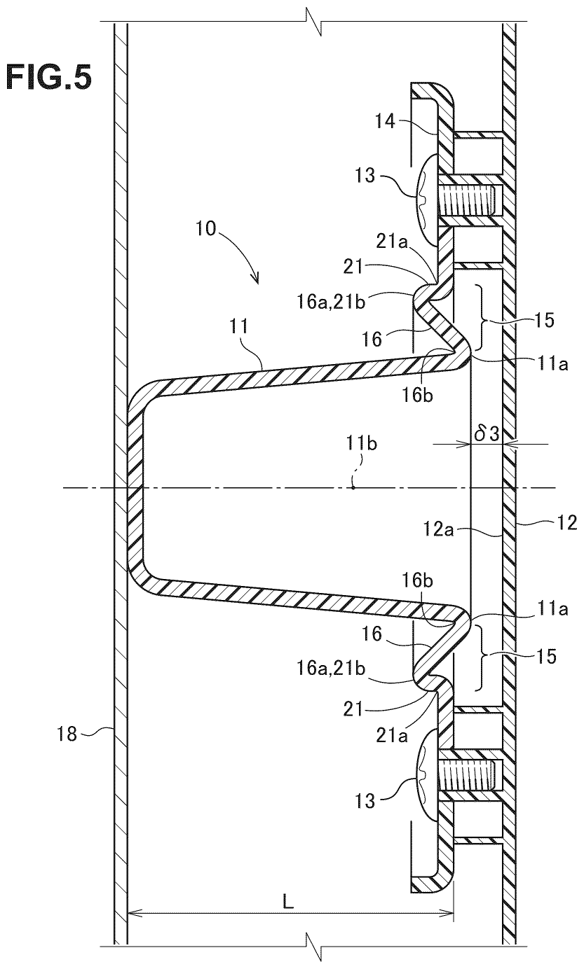

The form of the energy absorber 10 according to a fourth embodiment will be described with reference to FIG. 5.

The energy absorber 10 illustrated in FIG. 5 is different from that of FIG. 3 in that the distance between the rear surface of the door trim 12 and the tip of the base end 11a is set to δ3 smaller than δ1. Since the other elements are not changed, detailed description thereof will be omitted by using the reference numerals of FIG. 3.

That is, the rear surface of the door trim 12 has the base portion 23 protruding toward the door panel 18 and the base end 11a of the protrusion 11 is closer to the door trim 12 than the tip of the base 23 with respect to the extension direction of the axis 11b of the protrusion 11.

### Operation and Effect of Fourth Embodiment

Although there is a risk that the base end 11a may come into contact with the rear surface of the door trim 12, the distance L between the door panel 18 and the door trim 12 can be reduced. If the distance L is small, the vehicle door can be made compact.

### Energy Absorber According to Fifth Embodiment

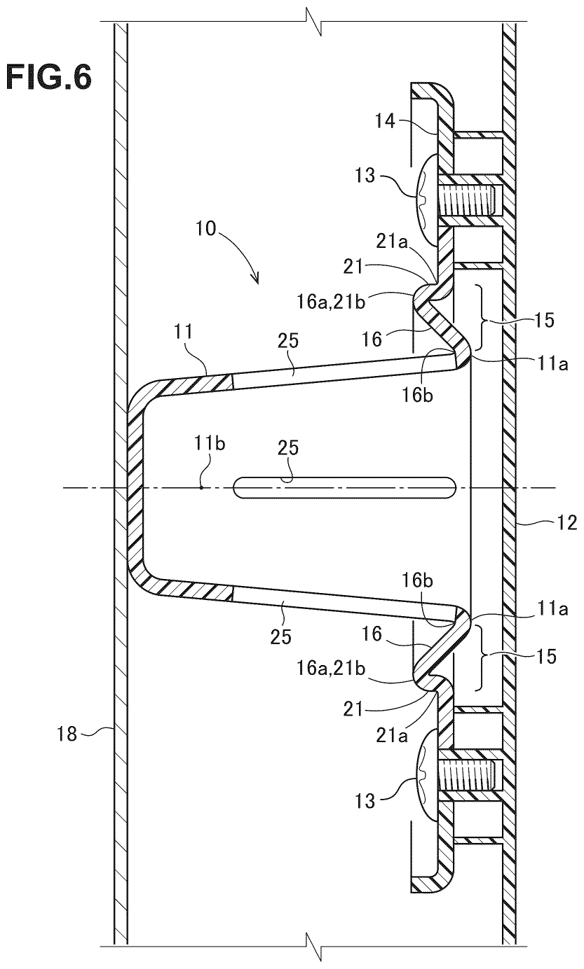

The form of the energy absorber 10 according to a fifth embodiment will be described with reference to FIG. 6.

The energy absorber 10 illustrated in FIG. 6 is different from that of FIG. 5 in that a plurality of elongated holes 25 extending along the axis 11b are provided in the protrusion 11. Since the other elements are not changed, detailed description thereof will be omitted by using the reference numerals of FIG. 5.

Although it is recommended that three elongated holes 25 are provided at a pitch of 120° along the circumference, four elongated holes 25 may be provided at a pitch of 90° along the circumference, and the number of holes is optional.

### Operation and Effect of Fifth Embodiment

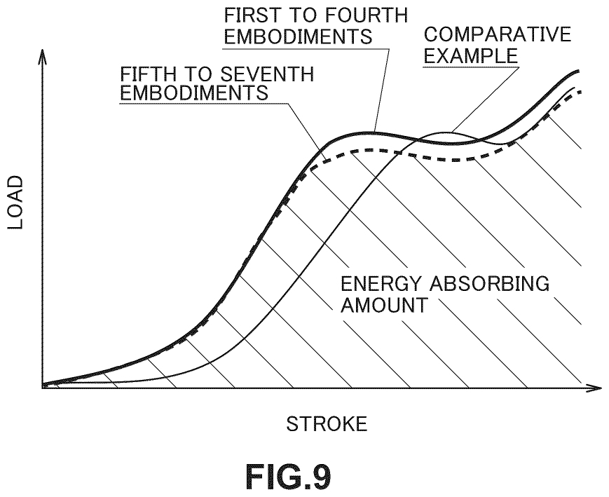

As will be described in detail later with reference to FIG. 9, the load during energy absorption can be suppressed to an appropriate value.

### Energy Absorber According to Sixth Embodiment

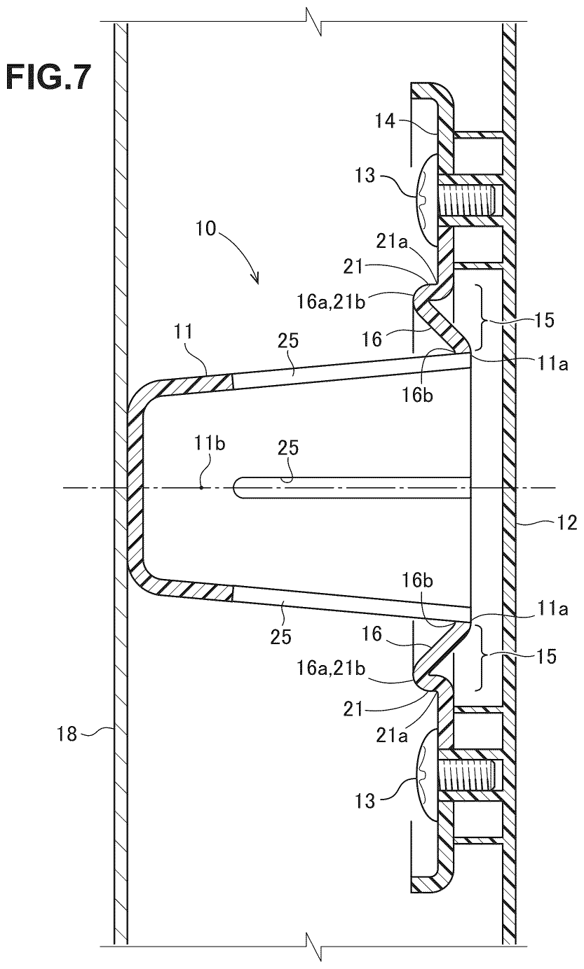

The form of the energy absorber 10 according to a sixth embodiment will be described with reference to FIG. 7.

The energy absorber 10 illustrated in FIG. 7 is different from that of FIG. 6 in the set range of the elongated hole 25. Specifically, the elongated hole 25 extends to the base end 11a of the protrusion 11. Since the other elements are not changed, detailed description thereof will be omitted by using the reference numerals of FIG. 6.

### Operation and Effect of Sixth Embodiment

Compared with the fifth embodiment, undercut processing of the mold for the energy absorber 10 is not necessary.

### Energy Absorber According to Seventh Embodiment

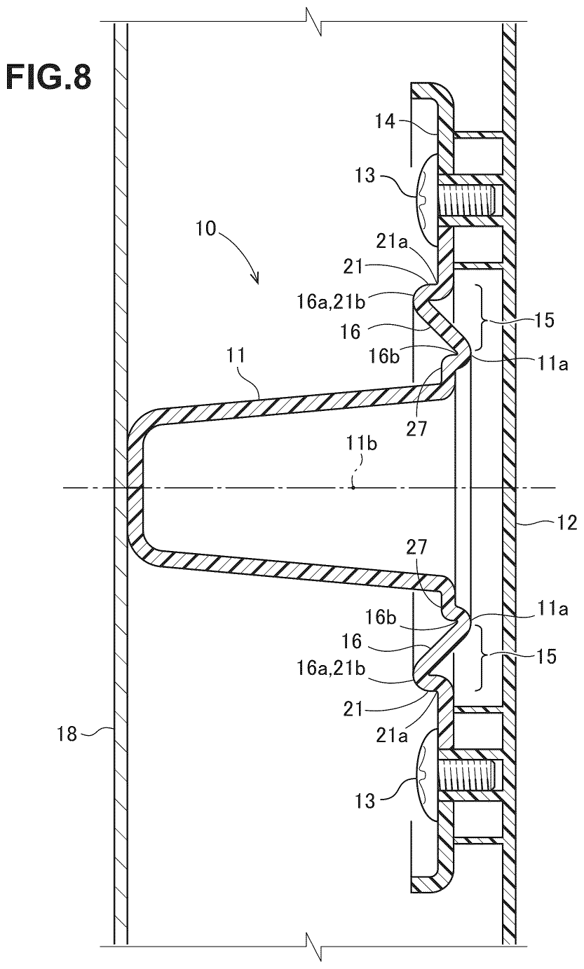

The form of the energy absorber 10 according to a seventh embodiment will be described with reference to FIG. 8.

The energy absorber 10 illustrated in FIG. 8 is different from that of FIG. 5 in that a second connecting portion 27 is interposed between the base end 11a of the protrusion 11 and the connecting portion 15. Since the other elements are not changed, detailed description thereof will be omitted by using the reference numerals of FIG. 5.

The second connecting portion 27 is an annular portion extending in parallel to the rear surface of the door trim 12, that is, a portion extending perpendicular to the axis 11b. Since the second connecting portion 27 is perpendicular to the axis 11b, the second connecting portion easily bends in a direction along the axis 11b when subjected to an external force. Therefore, the energy load is reduced.

### Operation and Effect of Seventh Embodiment

As will be described in detail later with reference to FIG. 9, the load during energy absorption can be suppressed to an appropriate value.

### Energy Absorbing Performance

FIG. 9 is a graph in which the horizontal axis represents the stroke, that is, the crush allowance, the vertical axis represents the force applied from the outside, that is, the energy load, and the shaded area represents the energy absorbing amount.

The first to fourth embodiments are illustrated by solid lines, and the fifth to seventh embodiments are illustrated by dashed lines.

The solid line and the dashed line have roughly the same rise, but the load after the rise (load roughly parallel to the horizontal axis) is smaller for the dashed line.

Therefore, in the fifth to seventh embodiments, the load during energy absorption can be suppressed to an appropriate value compared with the first to fourth embodiments.

What is claimed is:

1. A energy absorber provided between a vehicle door panel and a door trim covering the door panel from a passenger compartment and serving as an interior part of the passenger compartment, comprising:
a protrusion which protrudes from the door trim side toward the door panel side and has a tip capable of receiving the door panel and a base end spaced apart from a rear surface of the door trim; and
a fixing portion which is provided on an outer periphery of the base end of the protrusion and is fixable to the door trim,
wherein the base end of the protrusion and the fixing portion are connected through an annular connecting portion, and
wherein the connecting portion has an inclined portion which approaches the door trim as it moves radially inward with respect to an axis of the protrusion.

2. The energy absorber according to claim 1,
wherein the connecting portion has a second inclined portion which is spaced apart from the door trim as it moves radially inward with respect to the axis of the protrusion, and
wherein the second inclined portion connects the inclined portion and the fixing portion.

3. The energy absorber according to claim 2,
wherein the rear surface of the door trim has a base portion protruding toward the door panel side,
wherein the fixing portion is fixable to the base portion, and
wherein the base end of the protrusion with respect to an extension direction of the axis of the protrusion is located at the same position as a tip of the base portion.

4. The energy absorber according to claim 2,
wherein the rear surface of the door trim has a base portion protruding toward the door panel side, and
wherein the base end of the protrusion with respect to the extension direction of the axis of the protrusion is closer to the door trim than a tip of the base portion.

5. The energy absorber according to claim 3,
wherein a plurality of holes extending along the axis are provided in the protrusion.

6. The energy absorber according to claim 5,
wherein the hole extends to the base end of the protrusion.

7. The energy absorber according to claim 4,
wherein a plurality of holes extending along the axis are provided in the protrusion.

8. The energy absorber according to claim 7,
wherein the hole extends to the base end of the protrusion.

9. The energy absorber according to claim 3,
wherein a second connecting portion is interposed between the base end of the protrusion and the connecting portion, and
wherein the second connecting portion has an annular shape and extends in parallel to the rear surface of the door trim.

10. The energy absorber according to claim 4,
wherein a second connecting portion is interposed between the base end of the protrusion and the connecting portion, and
wherein the second connecting portion has an annular shape and extends in parallel to the rear surface of the door trim.
